(19) United States
(12) Patent Application Publication
(10) Pub. No.: US 2015/0342157 A1
(43) Pub. Date: Dec. 3, 2015

(54) AQUACULTURE PEN

(71) Applicant: DSM IP ASSETS B.V., Heerlen (NL)

(72) Inventors: Johannes Gabriël Marie DRIEMAN, Echt (NL); Hans SCHNEIDERS, Echt (NL)

(21) Appl. No.: 14/433,481

(22) PCT Filed: Oct. 9, 2013
(86) PCT No.: PCT/EP2013/071047

§ 371 Date: Apr. 3, 2015

(30) Foreign Application Priority Data
Oct. 11, 2012 (EP) 12188158.5

(51) Int. Cl. A01K 61/00; C09D 183/06; C09D 5/16

(52) U.S. Cl. CPC A01K 61/007; C09D 5/16; C09D 183/06

(57) ABSTRACT

The invention relates to the use of an antifouling composition and to an aquaculture pen for sheltering and feeding aquatic life, comprising: a) a supporting structure: and b) a netting attached to the supporting structure; said netting containing a continuously submerged portion, wherein said submerged portion of the netting defines a containment volume for containing the aquatic life; and wherein at least said submerged portion of the netting comprises an antifouling composition containing a cross-linked silicon polymer obtainable by cross-linking a silicon composition containing: i) a first silicon polymer having formula CH₂═CH—(Si(CH₃)₂—O)ₙ—CH═CH₂ wherein n is an integer from 2 to 200; ii) a cross-linker containing a second silicon polymer having formula Si(CH₃)₃—O—(SiCH₃H—O)ₘ—Si(CH₃)₃ wherein m is an integer from 2 to 200; and iii) a metal catalyst wherein the metal is chosen from the group consisting of platinum, palladium and rhodium.

The invention relates to an aquaculture pen for sheltering and feeding aquatic life, comprising a supporting structure and a netting attached to the supporting structure; said netting having a continuously submerged portion which defines a containment volume for containing the aquatic life and comprises an antifouling composition.

Aquaculture pens are known, examples thereof being disclosed by U.S. Pat. No. 8,210,125; U.S. Pat. No. 7,748,349; U.S. Pat. No. 7,509,922 and U.S. Pat. No. 6,539,894. A common problem however, with the continuously submerged portions of the netting of pens is fouling. Fouling, also referred to as biofouling, is an undesirable accumulation of microorganisms, plants, algae, and other organisms on marine structures residing for a prolonged time in water such as said portion of netting. By water herein is understood fouling water, i.e. water which has fouling properties, such as seawater or fresh water of rivers and the like. There are mainly two categories of fouling: (i) microfouling, sometimes referred to as slime formation, which is the formation of biofilms and/or bacterial adhesion; and (ii) macrofouling, which is the attachment to said structure of larger organisms, such as barnacles, teredos, tubeworms, algae, mussels, polychaete worms, bryozoans, and seaweed. First the microfouling takes place and is subsequently followed by the formation of macrofouling.

It has been found that many types of nettings when exposed to sea and fresh waters, may experience heavy levels of clogging due to macrofouling. Such clogging may limit the flow of water and it usually makes the nettings inordinately heavy, with weight increases as high as 1000%. Natural food penetration, acceptable oxygen levels, removal of fish wastes and detritus removal may be severely restricted, leading to loss of or poor crop yield. In addition, labour for frequent cleaning adds high costs and full utilization of the containment volume may be restricted due to the cleaning work.

Antifouling compounds have been used for decades with only partial success. Traditional antifouling coating treatments have relied on copper oxide and mercury compounds and other heavy metal compounds which are effective antifoulants, but are highly toxic and can be damaging to the aquatic life.

Less toxic compounds were developed with U.S. Pat. No. 7,928,175 and the references cited therein JP-A-62-252480, JP-B-63-2995, JP-A-5-78617, and JP-A-5-287203 describing antifouling paint compositions using reactive curable (cross-linkable) silicone rubber containing silicone oil, silicone resin having hydroxyl group, or polysiloxane having silanol group. JP-A-62-156172 describes an antifouling paint composition containing a polymer having polydimethylsiloxane group as a side chain.

However, silicon based coatings have gained little commercial acceptance in the field of aquaculture pens. This is mainly because such coatings primarily designed for coating ship hulls are too rigid and crack easily when used to coat nettings whose shape is not stable but heavily influenced by water currents, waves, movements of the aquatic life and the like. Also according to U.S. Pat. No. 5,663,215 it is difficult to make such coatings adhere well to nettings that need to be protected, and they are mechanically rather weak and liable to damage. More mechanically stable silicon based coatings were used to enhance the mechanical properties of fishing nets, however, fishing nets are nets that do not need antifouling coatings as they do not reside in water for sufficient time to allow for microfouling and even less for macrofouling.

Moreover, although having some resistance against micro- and macrofouling, the nettings of known aquaculture pens residing in water for prolonged time show a rather rapid slime formation and subsequently a progressive increase of macrofouling with all disadvantages associated therewith. An aim of the present invention may thus be to provide an aquaculture pen which mitigates to above mentioned disadvantages and in particular is less affected by fouling. A further aim of the invention may be to provide an aquaculture pen which shows reduced fouling and more in particular almost no fouling between two maintenance rounds which are carried out in a time interval of at least 2 weeks.

The invention provides an aquaculture pen wherein at least the continuously submerged portion of the netting comprises an antifouling composition containing a cross-linked silicon polymer obtainable by cross-linking a silicon composition containing:

i. a first silicon polymer having formula

CH₂═CH—(Si(CH₃)₂O)ₙ—CH═CH₂

wherein n is an integer from 2 to 200;

ii. a cross-linker containing a second silicon polymer having formula

Si(CH₃)₃O—(SiCH₃HO)ₘ—Si(CH₃)₃

wherein m is an integer from 2 to 200; and

iii. a metal catalyst wherein the metal is chosen from the group consisting of platinum, palladium and rhodium.

It was observed that the aquaculture pen of the invention may show reduced fouling while allowing for netting manipulation without the antifouling composition breaking off or showing signs of damage. It was observed that said pen is well protected against fouling by an antifouling composition which is flexible enough to avoid crack formation even when the netting is deformed by water currents or waves. In particular it was observed that the slime formation as well as the macrofouling formation on said pen may be effectively hindered for a prolonged time. Also, said pen provides a containment volume which is non-toxic and provides an ECO+ environment for breading, growing and sheltering aquatic life, effectively preventing thus toxic compounds, such as those leaking from known antifouling compositions, from entering the food chain.

As detailed hereinabove, the netting of an aquaculture pen is herein understood as a netting comprising a continuously submerged portion, i.e. a netting which resides in water for at least a period of time needed for microfouling to form and more preferably for at least a period of time needed for macrofouling to form; said time being determined on the netting free of any antifouling prevention and is usually a few days. Preferably the netting of the aquaculture pen of the invention resides in water for at least 2 weeks, more preferably at least 1 month, more preferably for at least 3 months, most preferably for at least 6 months. A netting for an aquaculture pen is thus subjected to different environmental factors than for example a fishing net which stays in water only for the duration of fishing which is usually a few hours. The submerged portion of the netting is chosen with due regard to the volume used for the containment of aquatic life and can be routinely chosen depending on various factors such as the amount, size and nature of the aquatic life.

It was also observed that when the netting of the aquaculture pen was manufactured from synthetic fibers, in particular high performance polyolefin fibers, more in particular ultrahigh molecular weight polyethylene fibers, the netting stayed free of fouling for the entire duration between two maintenance rounds carried out during 6 months. Hence, in a particular embodiment, the netting of the of the inventive aquaculture pen contained synthetic fiber, more preferably high performance polyolefin fibers. In most preferred embodiment, the netting of the of the inventive aquaculture pen contained ultrahigh molecular weight polyethylene fibers.

Preferred synthetic fibers are those manufactured from polymers including: polyesters, e.g. polyethyltherephthalate (PET); polyamides, e.g. Nylon 6 and Nylon 6,6; polyaramides, e.g. poly(p-phenylene terephthalamide) (known as Keeler®); poly(tetrafluoroethylene) (PTFE); aromatic copolyamid (co-poly-(paraphenylene/3,4′-oxydiphenylene terephthalamide)) (known as Technora®); poly{2,6-diimidazo-[4,5b-4′, 5′e]pyridinylene-1,4(2,5-dihydroxy)phenylene} (known as M5); poly(p-phenylene-2, 6-benzobisoxazole) (PBO) (known as Zylon®); thermotropic liquid crystal polymers (LCP) as known from e.g. U.S. Pat. No. 4,384,016; but also polyolefins e.g. homopolymers and copolymers of polyethylene and polypropylene. Also combinations of fibers manufactured from the above referred polymers can be used in said netting.

Preferred polyolefin fibers are fibers manufactured from homopolymers or copolymers of polypropylene or polyethylene. More preferably, the polyolefin is a polyethylene, most preferably an ultrahigh molecular weight polyethylene (UHMWPE). By UHMWPE is herein understood a polyethylene having an intrinsic viscosity (IV) of at least 3 dl/g, more preferably at least 4 dl/g, most preferably at least 5 dl/g. Preferably said IV is at most 40 dl/g, more preferably at most 25 dl/g, more preferably at most 15 dl/g. The IV may be determined according to ASTM D1601(2004) at 135° C. in decalin, the dissolution time being 16 hours, with BHT (Butylated Hydroxy Toluene) as anti-oxidant in an amount of 2 g/l solution, by extrapolating the viscosity as measured at different concentrations to zero concentration. Preferably, the UHMWPE fibers are gel-spun fibers, i.e. fibers manufactured with a gel-spinning process. Examples of gel spinning processes for the manufacturing of UHMWPE fibers are described in numerous publications, including EP 0205960 A, EP 0213208 A1, U.S. Pat. No. 4,413,110, GB 2042414 A, GB-A-2051667, EP 0200547 B1, EP 0472114 B1, WO 01/73173 A1, EP 1,699,954 and in “Advanced Fibre Spinning Technology”, Ed. T. Nakajima, Woodhead Publ. Ltd (1994), ISBN 185573 182 7.

By fiber is herein understood an elongated body having a length dimension and transverse dimensions, e.g. a width and a thickness or a diameter, wherein the length dimension is much greater than the transverse dimensions. The term fiber also includes various embodiments e.g. a filament, a ribbon, a strip, a band, a tape and the like having regular or irregular cross-sections. The fiber may have a continuous length, also referred to as a filament, or a discontinuous length in which case is referred to in the art as staple fibers. A preferred fiber for use in accordance with the invention is a filament having preferably an essentially rounded cross-section. A yarn for the purpose of the invention is an elongated body containing a plurality of fibers.

The synthetic fibers used in accordance with the present invention are preferably high strength, e.g. having a tensile strength of at least 0.5 GPa, more preferably of at least 1.2 GPa, even more preferably of at least 2.5 GPa, most preferably of at least 3.5 GPa. When polyolefin fibers are used and in particular when UHMWPE fibers are used, said fibers preferably have a tensile strength of at least 1.2 GPa, more preferably of at least 2.5 GPa, most preferably at least 3.5 GPa. Preferably the fibers have a tensile modulus of at least 30 GPa, more preferably of at least 50 GPa, most preferably of at least 60 GPa. When polyolefin fibers are used and in particular when UHMWPE fibers are used, said fibers have a tensile modulus of at least 50 GPa, more preferably of at least 60 GPa, most preferably of at least 80 GPa.

Preferably, the synthetic fibers, in particular the polyolefin fibers and more in particular the UHMWPE fibers employed by the invention have deniers in the range of from 0.5 to 20, more preferably from 0.7 to 10, most preferably from 1 to 5. If yarns containing said fibers are used to manufacture the netting, preferably said yarns have deniers in the range of from 100 to 10000, more preferably from 200 to 8000, most preferably from 800 to 3000. Preferably, yarns having a denier in the range of from 800 and 3000 and containing UHMWPE fibers having a denier per fiber of between 0.5 and 20 are used to manufacture the netting of the inventive pen since such it was observed that for such combination, the advantages of the invention were more prominent.

In a special embodiment, the synthetic fibers used in accordance to the invention have a tape-like shape or, in other words, said fibers are tapes. Preferably said tapes are polyolefin tapes, more preferably UHMWPE tapes. A tape (or a flat tape) for the purposes of the present invention is a fiber with a cross sectional aspect ratio, i.e. ratio of width to thickness, of preferably at least 5:1, more preferably at least 20:1, even more preferably at least 100:1 and yet even more preferably at least 1000:1. The tape preferably has a width of between 1 mm and 600 mm, more preferable between 1.5 mm and 400 mm, even more preferably between 2 mm and 300 mm, yet even more preferably between 5 mm and 200 mm and most preferably between 10 mm and 180 mm. The tape preferably has a thickness of between 10 μm and 200 μm and more preferably between 15 μm and 100 μm. By cross sectional aspect ratio is herein understood the ratio of width to thickness.

In the present invention, the netting of the inventive aquaculture pen comprises a submerged portion which contains an antifouling composition containing a cross-linked silicon polymer. Preferably, the entire netting comprises said composition. Preferably, said composition is used to coat the netting before cross-linking said polymer, such as to form a coating on said netting; and subsequently curing said polymer into a cross-linked state. An antifouling composition containing a cross-linked silicon polymer is hereinafter referred to also as a cured antifouling composition. Preferably, the amount of cured antifouling composition is at least 0.5 wt % of the netting calculated with reference to the weight of the netting. More preferably, said amount is at least 1.0 wt %, most preferably at least 1.5 wt %. Said amount is preferably at most 40 wt %, more preferably at most 35 wt %, most preferably at most 30 wt %.

In a preferred embodiment, said netting comprises yarns containing synthetic fibers, in particular polyolefin or UHMWPE fibers, wherein said yarns also contains the cured antifouling composition, wherein the cured antifouling composition preferably coats at least a part of said fibers' length. Most preferably, said netting comprises yarns, the yarns containing the cured antifouling composition, wherein the cured antifouling composition is in an amount of preferably at least 1.0 wt % of the weight of the yarn, more preferably at least 1.5 wt %, most preferably at least 2 wt %. Preferably, said amount is at most 30 wt % of the weight of the yarn, more preferably at most 20 wt %, most preferably at most 15 wt %.

The wt % is calculated by weighing the netting or the yarn, respectively, before coating and after coating and curing.

The antifouling composition used in accordance with the invention comprises a cross-linked silicon polymer. Before cross-linking said polymer, said composition can be applied directly on the netting of the inventive aquaculture pen or on the yarns or fibers before netting production if yarns or fibers are used to manufacture thereof. After being applied, said composition is cured, e.g. by heating to cause cross-linking of the first silicone polymer. The cross-linking may also be induced by any other suitable methods known to the skilled person.

If heating is used for cross-linking, said cross-linking is preferably carried out at a curing temperature of from 20 to 200° C., more preferably from 50 to 170° C., most preferably from 120 to 150° C. The curing temperature should not be too low, for the curing to be effective but also in case the netting comprises synthetic fibers not too high as there is a risk that the fibers may deteriorate.

The degree of the cross-linking of said silicon polymer may be controlled by e.g. the temperature or the time period of the heating. The degree of the cross-linking, if performed in other ways, may be controlled by methods known to the skilled person. The measurement of the degree of the cross-linking may be performed as follows: a coated object, e.g. netting or yarn or a part thereof, which is provided with the cured antifouling composition is dipped in a solvent that dissolves said silicon polymer in a non-cross-linked state, preferably hexane. By weighing said object before and after the dipping, the amount of the non-cross-linked polymer can be determined and a ratio of the cross-linked and non-cross-linked silicone amount can be determined. Said ratio is taken as an indication of the degree of the cross-linking.

The preferred degree of cross-linking of the antifouling composition, i.e. the degree of cross-linking of the silicon polymer contained therein, used in accordance with the invention is at least 10%, or in other words at least 10% of the coating remains on the coated object, e.g. netting or yarn, after extraction with the solvent, said % being calculated with respect to the total amount of the coating applied. More preferably the degree of cross-linking is at least 20%, most preferably at least 30%. It was observed that for such cross-linking degrees, the advantages of the invention were more noticeable.

The cross-linked silicon polymer in the antifouling composition used in accordance with the invention is obtained by cross-linking a silicon composition comprising a first silicon polymer. Herein, no distinction is made between the term obtainable by and the term obtained by and they can be used interchangeably.

Preferably, the first silicone polymer comprises a reactive end-group. It was found that a cross-linking in the end-groups of the first silicone polymer shows good advantages. A silicone polymer which is cross-linked at the end groups rather than at the branches in the repeating unit provides the antifouling composition used in accordance with the invention with better properties. Preferably, the cross-linkable end-group is an alkylene end group, more preferably a C₂-C₆ alkylene end group. In particular the end group is a vinyl group or a hexenyl group. A vinyl group is preferred.

Preferably, the first silicone polymer has the formula:

CH₂═CH (Si(CH₃)₂—O)ₙ—CH═CH₂ (1)

wherein n is a number from 2 to 200, preferably from 10 to 100, more preferably from 20 to 50.

Preferably, the silicon composition further contains a cross-linker. The cross-linker preferably contains a second silicon polymer having the formula:

Si(CH₃)₃—O(SiCH₃H—O)ₘ—Si(CH₃)₃ (2)

wherein m is a number from 2 to 200, preferably from 10 to 100, more preferably from 20 to 50.

Preferably, the silicon composition further comprises a metal catalyst to facilitate cross-linking, the metal catalyst preferably being a platinum, palladium or rhodium, more preferably platinum metal complex catalyst. Such catalysts are known to the skilled person.

Preferably, the silicon composition is a multi-component system comprising a first emulsion comprising the first silicone polymer and the cross-linker and a second emulsion comprising the first silicone polymer and the metal catalyst.

Preferably, the weight ratio between the first emulsion and the second emulsion is from about 100:1 to about 100:30, preferably 100:5 to 100:20, more preferably 100:7 to 100:15.

The silicon polymers and compositions as described above are known in the art. They are often referred to as addition-curing silicone coatings or coating emulsions. The cross-linking or curing takes place when e.g. the vinyl end groups of the first silicon polymer react with the SiH group of the second silicon polymer of the cross-linker.

Examples include Dehesive® 430 (cross-linker) and Dehesive® 440 (catalyst) from Wacker Silicones; Silcolease® Emulsion 912 and Silcolease® catalyst 913 from Bluestar Silicones; and Syl-off® 7950 Emulsion Coating and Syl-off® 7922 Catalyst Emulsion from Dow Corning.

Preferably, the antifouling composition further contains functional additives, e.g. colorants, anti-oxidants, UV-stabilizers, fire inhibitors and the like.

It was observed that the antifouling composition used in accordance to the invention is also efficient when utilized on other marine structures such as submerged portions of ships such as the hull, offshore marine structures such as oil rigs, sea water conduit systems for seaside plants, buoys, heat-exchangers, cooling towers, de-salination equipment, filtration membranes, docks, and the like which may experience some degree of fouling when continually exposed to water. In the case of ships, fouling can inhibit vessel performance and capabilities. For example, fouling may substantially increase fuel consumption and may necessitate extensive and more frequent maintenance, all of which raise the overall costs of operation. Fouling may also reduce ship speed, manoeuvrability, and range, which impede performance. On another level, attachment of regionally specific aquatic organisms on ships that traverse the world can lead to the unwanted invasion and infestation of these organisms to non-indigenous harbours. In some instances, this can have severe adverse effects on local aquatic ecosystems. The antifouling composition used in accordance to the invention may be used to alleviate such unwanted factors. Therefore, the invention relates to a continuously submerged substrate containing the antifouling composition used in accordance to the invention, wherein the substrate is preferably one of the other marine structures as enumerated immediately hereinabove.

The invention also relates to a continuously submerged netting comprising the antifouling composition used in accordance to the invention.

The invention also relates to a process for inhibiting fouling of a substrate continuously submerged in a fouling environment, comprising (i) applying to the substrate, preferably before exposure to said environment, the antifouling composition used in accordance with the invention; (ii) submerging said substrate in said fouling environment; and (iii) keeping said substrate in said environment for at least a period of time needed for microfouling to form and more preferably for at least a period of time needed for macrofouling to form, said time being determined on said substrate without said antifouling composition. Preferably, said substrate is kept in said fouling environment for at least 3 months, more preferably for at least 4 months, most preferably for at least 6 months. The substrate is preferably a netting, e.g. the netting of an aquaculture pen, or one of the other marine structures as enumerated hereinabove.

The invention also relates to the use of the composition utilized in accordance with the invention for providing antifouling characteristics to substrates.

### MEASURING METHODS

Tensile properties, i.e. strength and modulus, of synthetic fibers, e.g. polyolefin and in particular UHMWPE fiber, were determined on multifilament yarns as specified in ASTM D885M, using a nominal gauge length of the fibre of 500 mm, a crosshead speed of 50%/ min and Instron 2714 clamps, of type Fibre Grip D5618C. For calculation of the strength, the tensile forces measured are divided by the titre, as determined by weighing 10 metres of fibre; values in GPa for are calculated assuming the natural density of the polymer, e.g. for UHMWPE is 0.97 g/cm³.

The tensile properties, i.e. strength and modulus, of synthetic tapes, e.g. polyolefin and in particular UHMWPE tapes were defined and determined at 25° C. on tapes of a width of 2 mm as specified in ASTM D882, using a nominal gauge length of the tape of 440 mm, a crosshead speed of 50 mm/min.

### COMPARATIVE EXPERIMENT (CE)

A netting was made from synthetic yarns comprising ultrahigh molecular weight polyethylene fibers sold by DSM Dyneema® as SK75. The netting coated by dipping with various antifouling coatings and was subsequently submerged for a prolonged period of time in the Mediterranean sea. Also an uncoated net was used. The results are presented in Table.

### EXAMPLE (EX)

The netting above was coated by dipping at room temperature with a silicon composition prepared from a first emulsion comprising a reactive silicone polymer preformulated with a cross-linker and a second emulsion comprising a silicone polymer and a metal catalyst. The first emulsion was an emulsion available from Dow Corning containing 30.0-60.0 wt % of dimethylvinyl-terminated dimethyl siloxane and 1.0-5.0 wt % of dimethyl, methylhydrogen siloxane (Syl-off®7950 Emulsion Coating). The second emulsion was an emulsion available from Dow Corning containing 30.0-60.0 wt % of dimethylvinyl-terminated dimethyl siloxane and a platinum catalyst (Syl-off®7922 Catalyst Emulsion). The first emulsion and the second emulsion were mixed at a weight ratio of 8.3:1 and diluted with water to a concentration of 4 wt %.

To cure the composition, the netting was heated in an oven at a temperature of 120° C. so that cross linking takes place.

| | | Coating | | After |
|---|---|---|---|---|
| Sample | Antifouling | characteristics | After 3 months | 6 months |
| CE1 | Flexgard red | CuOx based | Slime formation and | Heavy |
| | XI-I | 23% conc. | fouling | fouling |
| | (Flexabar) | | | |
| CE2 | NetWax NI | CuOx based | Slime formation and | Heavy |
| | Gold (Net | | fouling | fouling |
| | Kem) | | | |
| CE4 | None applied | — | Slime formation and | Heavy |
| | | | fouling | fouling |
| EX | | | Reduced slime | No fouling |
| | | | formation and no | |
| | | | fouling | |

1. An aquaculture pen for sheltering and feeding aquatic life, comprising:
a. a supporting structure: and
b. a netting attached to the supporting structure; said netting containing a continuously submerged portion,
wherein said submerged portion of the netting defines a containment volume for containing the aquatic life; and
characterized in that at least said submerged portion of the netting comprises an antifouling composition containing a cross-linked silicon polymer obtainable by cross-linking a silicon composition containing;
i. a first silicon polymer having formula
CH₂═CH—(Si(CH₃)₂—O)ₙ'CH═CH₂
wherein n is an integer from 2 to 200;
ii. a cross-linker containing a second silicon polymer having formula
Si(CH₃)₃—O—(SiCH₃H—O)ₘ—Si(CH₃)₃
wherein m is an integer from 2 to 200; and
iii. a metal catalyst wherein the metal is chosen from the group consisting of platinum, palladium and rhodium.

2. The pen of claim 1 wherein said portion is continuously submerged for at least 2 weeks.

3. The pen of claim 1 wherein the netting contains synthetic fibers, preferably polyolefin fibers, more preferably ultrahigh molecular weight polyethylene fibers.

4. The pen of claim 1 wherein the netting contains synthetic fibers preferably polyolefin fibers, more preferably ultrahigh molecular weight polyethylene fibers, the fibers having a tensile strength of at least 0.5 GPa.

5. The pen of claim 1 wherein the netting contains yams comprising synthetic fibers said yams having a denier between 100 and 10000.

6. The pen of claim 1 wherein the amount of antifouling composition containing a cross-linked silicon polymer is at least 0.5 wt % of the netting calculated with reference to the weight of the netting.

7. The pen of claim 1 wherein the netting contains yams comprising synthetic fibers and the antifouling composition in an amount of preferably at least 1.0 wt % of the weight of the yarn.

8. The pen of claim 1 wherein the degree of cross-linking of the silicon polymer is at least 10%.

9. The pen of claim 1 wherein the first silicone polymer comprises a reactive end-group.

10. The pen of claim 1 wherein the metal catalyst is platinum.

11. The use of an antifouling composition containing a cross-linked silicon polymer obtainable by cross-linking a silicon composition containing:
i. a first silicon polymer having formula
CH₂═CH—(Si(CH₃)₂—O)ₙ'CH═CH₂
wherein n is an integer from 2 to 200;
ii. a cross-linker containing a second silicon polymer having formula
Si(CH₃)₃—O—(SiCH₃H—O)ₘ—Si(CH₃)₃
wherein m is an integer from 2 to 200; and
iii. a metal catalyst wherein the metal is chosen from the group consisting of platinum, palladium and rhodium,
on marine structures which may experience some degree of fouling when continually exposed to water.

12. A process for inhibiting fouling of a substrate continuously submerged in a fouling environment, comprising (a) applying to the substrate an antifouling composition containing a cross-linked silicon polymer obtainable by cross-linking a silicon composition containing:
i. a first silicon polymer having formula
CH₂═CH—(Si(CH₃)₂—O)ₙ'CH═CH₂
wherein n is an integer from 2 to 200;
ii. a cross-linker containing a second silicon polymer having formula
Si(CH₃)₃—O—(SiCH₃H—O)ₘ—Si(CH₃)₃
wherein m is an integer from 2 to 200; and
iii. a metal catalyst wherein the metal is chosen from the group consisting of platinum, palladium and rhodium; (b) submerging said substrate in said fouling environment; and (c) keeping said substrate in said environment for at least a period of time needed for microfouling to form and more preferably for at least a period of time needed for macrofouiing to form, said periods of time being determined by keeping said substrate without said antifouling composition in said environment
